(19) United States
(12) Patent Application Publication
(10) Pub. No.: US 2015/0101426 A1
(43) Pub. Date: Apr. 16, 2015

(54) HUMAN BODY SIMULATOR FOR TRANSPORT LITTER TESTING AND TRAINING

(71) Applicant: Skedco, Inc., Tualatin, OR (US)

(72) Inventor: Carston R. Calkin, Tualatin, OR (US)

(21) Appl. No.: 14/506,474

(22) Filed: Oct. 3, 2014

Related U.S. Application Data
(60) Provisional application No. 61/890,080, filed on Oct. 11, 2013.

(51) Int. Cl. G09B 23/30; A61G 1/048; A61G 1/01; A61G 1/04

(52) U.S. Cl. CPC G09B 23/30; A61G 1/04; A61G 1/048; A61G 1/01
USPC 73/866.4

(57) ABSTRACT

Simulating load conditions for training purposes or for testing a patient transport litter having an elongate, flexible panel including a periphery and multiple handles attached to the periphery entails placing a water-fillable human body simulator bag on the flexible panel, filling the bag with water to form a water-filled simulator emulating human body weight of an incapacitated person sized to overlay an area of the flexible panel within the periphery, restraining the water-filed simulator within the litter by fastening portions of the periphery to each other with securement straps, and suspending the water-filed simulator by lifting the multiple handles.

### RELATED APPLICATION

This application claims benefit of U.S. Provisional Patent Application No. 61/890,080, filed Oct. 11, 2013, which is incorporated herein by reference in its entirety.

### TECHNICAL FIELD

This disclosure relates generally to a ballast-fillable container for simulating a human body, and, more particularly, to a fluid-fillable bag emulating human body features and proportions for patient transport litter testing, or for training emergency medical personnel to carry human beings safely in patient transport litters.

### BACKGROUND INFORMATION

Successful evacuation of rescued persons and effective transportation of medical patients entails rapid and safe transport litter (also referred to as a stretcher) deployment. Time and effort expended by caregivers attempting to deploy an unfamiliar transport litter may cause inefficient loading, transporting, and unloading of the litter, which adversely affects the comfort, safety, or healthcare outcome of a person transported in the litter. Deploying a previously untried transport litter could prove to be disastrous should the loaded stretcher break or overwhelm those carrying it.

Increasing numbers of bariatric patients present challenges to healthcare service providers, such as first responders. For example, many bariatric patients—due to their size and difficulty with mobility—require assistance with numerous activities of daily living. Moving these patients often necessitates coordinated lifting among multiple caregivers. Especially large patients with diminished mobility pose greater risks of injury for their caregivers because these patients depend upon greater numbers of people to move them about. Likewise, obese persons present similar challenges for confined-space rescue teams tasked with evacuating heavy people over treacherous terrain. Without proper transport litter training, healthcare service providers, rescuers, and their charges are susceptible to injury during use of the litter.

### SUMMARY OF THE DISCLOSURE

Disclosed is a human body simulator for stretcher testing or for training confined-space rescue evacuation teams, healthcare service providers, or other caregivers. The simulator has front, back, and sidewall panels made of rugged Hypalon® material. The front and back panels are sized and contoured to approximate a human being silhouette, and the sidewall panel has a width (from front to back panels) sized to approximate a width of human being torso profile. Peripheries of the front and back panels are joined to those of the sidewall panel to define a bag having an interior cavity that is completely hollow so as not to impede flow of water or other ballast liquids from completely filling the interior cavity. When the simulator is placed in a transport litter, filled, and carried by multiple straps of the transport litter, the simulator approximates the shape, weight, movement, and other physical properties of an incapacitated human body lying in a supine position inside the litter. The simulator is used in place of a rigid mannequin to simulate weight, size, and shape of an actual patient. Because the simulator is flexible, it more readily simulates packing a human in a stretcher.

Additional aspects and advantages will be apparent from the following detailed description of embodiments, which proceeds with reference to the accompanying drawings.

### BRIEF DESCRIPTION OF THE DRAWINGS

FIGS. 1-6 are isometric; front and back plan; and right, top and bottom side elevation views of a water-fillable human body simulator bag filled with water to form a water-filled simulator emulating human body shape and weight of an incapacitated person.

FIG. 7 is a perspective view of the water-filled simulator strapped inside a transport litter, according to one embodiment.

FIG. 8 is an isometric view of a water-fillable human body simulator bag filled with water to form a water-filled simulator emulating an average healthy adult human body shape and weight.

### DETAILED DESCRIPTION OF EMBODIMENTS

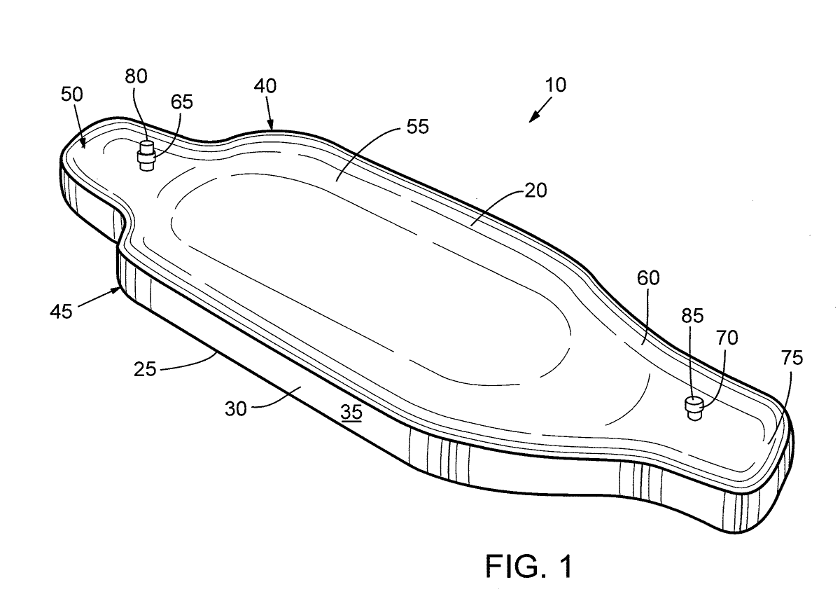

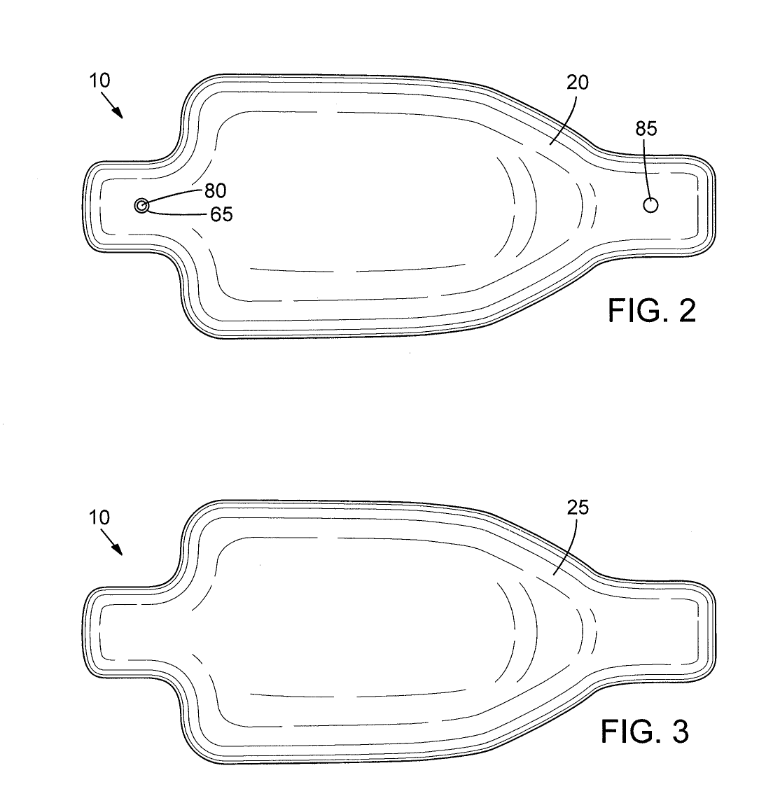

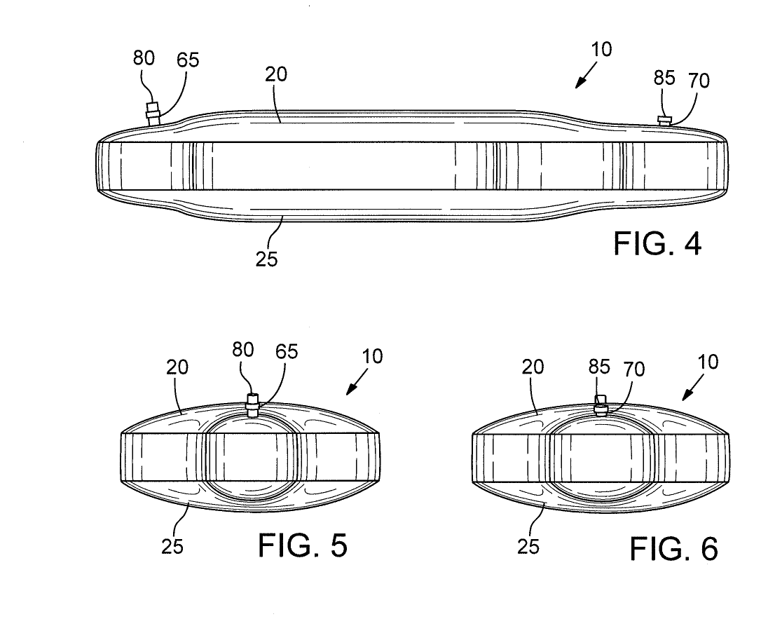

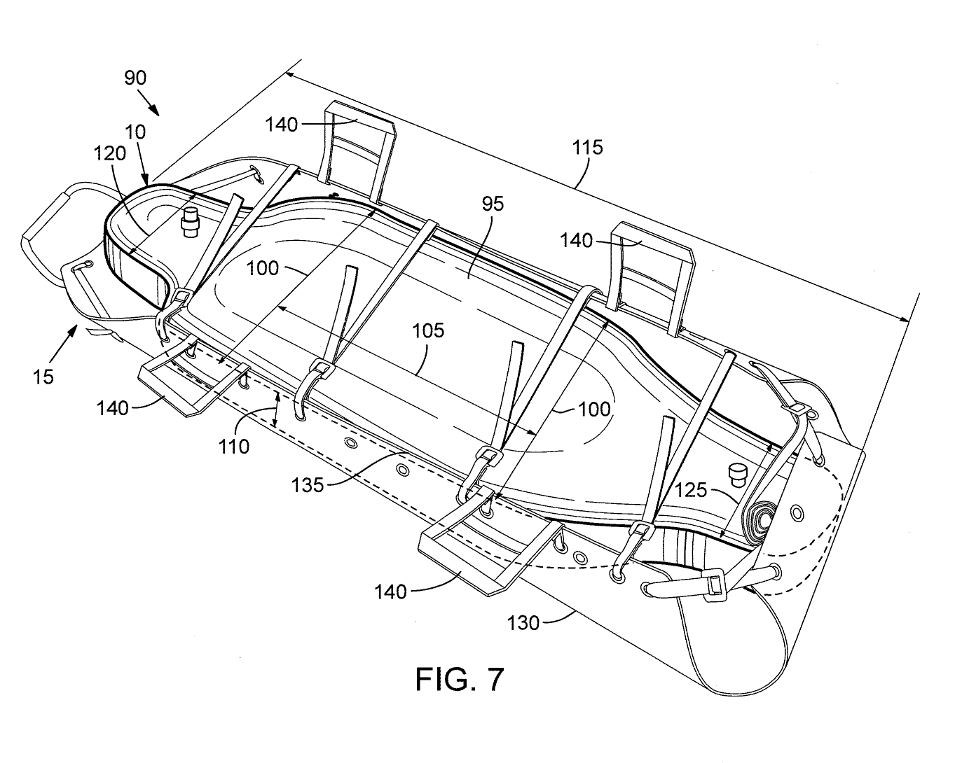

FIGS. 1-6 show an unrestrained water-fillable human body simulator bag 10 suitable for simulating peak load conditions during transport litter 15 (FIG. 7) testing or training exercises using the litter 15. The bag 10 includes front and back panels 20, 25 joined to a sidewall panel 30 that forms a side margin 35 of the bag 10. The front and back panels 20, 25 have similar (or identical) perimeter contours 40, 45 including head, upper-, and lower-body shaped regions 50, 55, 60. The perimeter contours 40, 45 are suitably joined to the sidewall panel 30 to form a hollow internal cavity (not shown) that is fillable through plastic spouts 65, 70 that receive water or other ballast. For example, the spout 65 at the head-shaped region 50 of the bag 10 is located in a position that roughly corresponds to the vicinity of a human being's mouth. The spout 65 may be used to fill (or empty) the bag 10 while the spout 70 located at a foot 75 of the bag 10 is open to release (or receive) air displaced by ballast. Alternatively, the spout 70 may be used to fill the bag 10 while the spout 65 is open, or both the spouts 65, 70 may be used simultaneously to fill the bag 10. Once the bag 10 is sufficiently filled, plastic caps 80, 85 are screwed or fastened onto the respective spouts 65, 70. In some embodiments, inside surfaces (not shown) of the spouts 65, 75 include hose threads to engage a garden hose or other nozzle for filling the bag with water.

The bag 10 is constructed of fabric coated with chlorosulfonated polyethylene (CSPE) synthetic rubber. CSPE is commonly referred to as the former brand name Hypalon®, which is a trademark owned by DuPont of Wilmington, Delaware. Fabrics coated in CSPE are commonly referred to as chlorosulfonated material (CSM). Such fabrics usually include CPSE rubber sheeting over a pair of neoprene layers with textile reinforcement layer between the neoprene layers. CSM is durable and resistant to harsh environments. It has high air retention, resists mildew, UV deterioration, and damage from chemicals.

In some other embodiments, the bag 10 may be constructed of polyvinyl chloride (PVC), which is a vinyl-based material similar to Hypalon® in terms of its resilience to ultraviolet light degradation. Still other embodiments may include urethane panels, or other materials.

FIG. 7 shows a transport litter training apparatus in the form of a kit 90 including the bag 10 filled with water to form a water-filled simulator 95 emulating human body weight of an incapacitated person inside the litter 15. The water-filled simulator 95 is sized to represent a width 100, a length 105, and thickness 110 of a human torso; a length 115 corresponding to the height of an adult human being; and widths 120 and 125 of, respectively, a human head and legs. For example, FIG. 7 shows that the bag 10 has an 11-inch head width 120, 36-inch shoulder-to-shoulder and waist widths 100, a 14-inch foot width 125, a 72-inch length 115 that includes a 32-inch torso length 105, and a 9-inch thickness 110. Accordingly, the bag 10 has a dry weight of 11 pounds and may be filled with roughly 75 gallons of water, reaching a total weight of up to 625 pounds. In some embodiments, the bag 10 is filled with water to emulate a bariatric patient having a weight in the range of approximately 400 pounds to approximately 625 pounds.

The transport litter 15 has an elongate, flexible panel 130 including a periphery 135 and multiple handles 140 attached to the periphery 135. The flexible panel 130 is sized to completely underlay an adult human being, or, for training purposes, the bag 10. The bag 10 and transport litter 15 are provided as the kit 90 that may be used for confined-space rescue training, load testing, caregiver training, and other related activities in which the free-standing water-fillable human body simulator bag 10 is placed on the flexible panel 130 and filled with water to emulate the body weight of an incapacitated person when the bag 10 is suspended or carried by the multiple handles 140. An example transport litter is described in U.S. Pat. No. 8,677,530, which is incorporated herein by reference in its entirety.

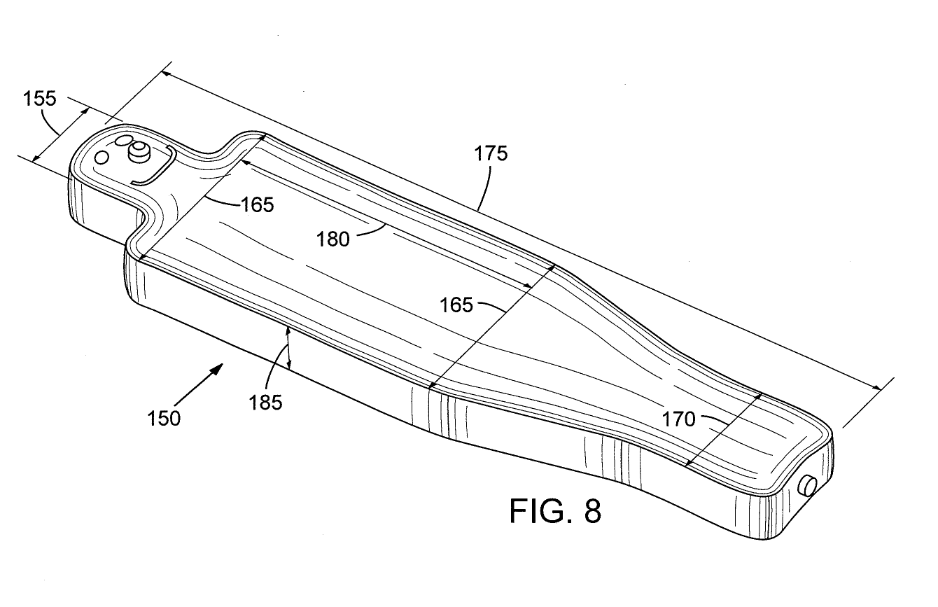

FIG. 8 shows another embodiment of a human body simulator sized to simulate an average-sized adult human being. For example, FIG. 8 shows that the simulator bag 150 has an 11-inch head width 155, 21-inch shoulder-to-shoulder and waist widths 165, a 14-inch foot width 170, a 72-inch length 175 that includes a 32-inch torso length 180, and a 6-inch thickness 185. Accordingly, the bag 150 has a dry weight of 9 pounds and may be filled with roughly 30 gallons of water, reaching a total weight of up to 250 pounds. In some embodiments, the bag 150 is filled with water to emulate a typical adult patient having a weight in the range of approximately 100 pounds to approximately 250 pounds.

It will be understood by skilled persons that many changes may be made to the details of the above-described embodiments without departing from the underlying principles of the invention. The scope of the present invention should, therefore, be determined only by the following claims.

1. A transport litter training apparatus, comprising:
a transport litter having an elongate, flexible panel including a periphery and multiple handles attached to the periphery, the flexible panel sized to completely underlay an adult human being; and
a water-fillable human body simulator bag to be placed on the flexible panel to emulate a human body when the bag is filled with water.

2. The transport litter training apparatus of claim 1, in which the human body simulator includes chlorosulfonated polyethylene synthetic rubber panels, including front and back panels joined to a sidewall panel, the front and back panels having matching perimeter contours including head, upper-, and lower-body shaped regions.

3. The transport litter training apparatus of claim 2, in which the lower-body shaped region of the front panel includes a plastic stem and a removable stem cap, the stem sized to receive a hose free-end that dispenses water into the bag.

4. The transport litter training apparatus of claim 1, in which the bag is sized to emulate a bariatric patient having a weight in the range of approximately 400 pounds to approximately 625 pounds.

5. A method of simulating load conditions for a transport litter having an elongate, flexible panel including a periphery and multiple handles attached to the periphery, the method comprising:
placing a water-fillable human body simulator bag on the flexible panel;
filling the bag with water to form a water-filled simulator emulating human body weight of an incapacitated person sized to overlay an area of the flexible panel within the periphery;
restraining the water-filed simulator within the litter by fastening portions of the periphery to each other with securement straps; and
suspending the water-filed simulator by lifting the multiple handles.

6. The method of claim 5, further comprising carrying the water-filed simulator in the litter.

7. The method of claim 5, further comprising filling the bag with water to form the water-filed simulator emulating a volume and center of mass of a human body.

8. The method of claim 5, further comprising filling the bag with water while the bag is suspended to determine peak load conditions of the litter.

9. The method of claim 8, in which the weight of the water-filled simulator peak load conditions emulates a bariatric patient having a weight in the range of approximately 400 pounds to approximately 650 pounds.

10. The method of claim 5, in which the water-filled simulator includes left and right side margins sized to represent a width of a human torso profile, and the restraining comprises wrapping lateral portions of the flexible panel to confront and conceal the left and right side margins.

11. A water-fillable human body simulator bag for placement on a transport litter to emulate a human body when the bag is filled with water, the bag comprising:
a sidewall panel having a side margin sized to represent a width of a human torso profile; and
front and back panels joined to the sidewall panel, the front and back panels including a length corresponding to the height of an adult human being and having matching perimeter contours defining head, upper-, and lower-body shaped regions;
a head width of the head shaped region corresponding to a temple-to-temple distance on a human being;
a foot width of the lower-body shaped region, the foot width being wider than the head width; and
a shoulder-to-shoulder width, a waist width, and a torso length of the upper-body region, the shoulder-to-shoulder width corresponding to a first widest distance between opposing sidewalls and proximal a rounded shoulder region of the bag, the waist width corresponding to a second widest distance between the opposing sidewalls and located between the upper- and lower-body shaped regions, the torso width corresponding to a distance between the shoulder-to-shoulder and waist widths, the torso width being shorter than the shoulder-to-shoulder and waist widths to emulate proportions of a bariatric patient.

12. The water-fillable human body simulator bag of claim 11 in which the bag is sized to be filled with approximately 75 gallons of water.

13. The water-fillable human body simulator bag of claim 11 in which the first and second widest distances are approximately equal.

14. The water-fillable human body simulator bag of claim 11 in which length is about 72 inches.

15. The water-fillable human body simulator bag of claim 11 in which shoulder-to-shoulder width is about 36 inches.
